(19) United States
(12) Patent Application Publication
(10) Pub. No.: US 2008/0159199 A1
(43) Pub. Date: Jul. 3, 2008

(54) SYSTEM AND METHOD FOR MANAGING FORWARD CHANNEL ACCESS USING A REVERSE CHANNEL

(75) Inventors: DIPENDRA M. CHOWDHARY, HOFFMAN ESTATES, IL (US); JOHN P. BELMONTE, ELK GROVE VILLAGE, IL (US); KEVIN M. ITTNER, CHICAGO, IL (US); DAVID G. WIATROWSKI, WOODSTOCK, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/619,386

(22) Filed: Jan. 3, 2007

(51) Int. Cl. H04B 7/14

(52) U.S. Cl. 370/315

(57) ABSTRACT

A system and method for managing forward channel access using a reverse channel in a wireless communication system is disclosed. A repeater receives requests on a reverse channel to access a forward channel. Each request includes a priority. The repeater selects a request based upon the priority. The repeater then allows access to the forward channel for a transmission based upon the selected request.

### FIELD OF THE INVENTION

The present invention generally relates to wireless communication systems and more particularly to managing forward channel access using a reverse channel in a wireless communication system.

### BACKGROUND

A wireless communication system may generally comprise a group of subscribers and a set of stationary “base radios” (also known as “repeaters”). The subscribers are typically endpoints of a communication path and the repeaters are typically the intermediaries by which a communication path to a subscriber may be established or maintained. During communication amongst the subscribers, a member of the group speaks while the other subscribers listen. Such a technique is particularly applicable in push-to-talk communications where a subscriber can simultaneously address every member of the group by simply pushing a transmit button. When the speaker ends a transmission, more than one member of the group might be interested to speak in response to the speaker's transmission and thereby access a channel for the transmission. Members that are interested in speaking will try to access the channel at the same time and this causes collisions.

As is known, one way to avoid these collisions is to randomly delay access to the channel for the rest of the members of the group when one speaker ends a transmission. Utilizing random delay to avoid collisions increases access time. When the number of subscribers in the group increases the size of the random delay access window is increased so as to spread subsequent access attempts over time and minimize the probability of a collision and this increased access time is undesirable. Currently, in a wireless communication system for groups, there is no available mechanism which facilitates access to the channel used for transmissions when a speaker has ended a transmission. Accordingly, there is such a need.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a system diagram of a wireless communication system configured in accordance with one example of the invention;

FIG. 2 illustrates a block diagram of a two-slot TDMA system configured in accordance with one example of the invention;

FIG. 3 illustrates a flow diagram of an operation of the wireless communication system configured in accordance with one example of the invention;

FIG. 4 illustrates a flow diagram of an operation by a repeater configured in accordance with one example of the invention; and

FIG. 5 illustrates a message flow diagram of an operation of the wireless communication system configured in accordance with one example of the invention.

Skilled artisans will appreciate that elements in the figures are illustrated for simplicity and clarity and have not necessarily been drawn to scale. For example, the dimensions of some of the elements in the figures may be exaggerated relative to other elements to aid in the understanding of the embodiments of the present invention.

### DETAILED DESCRIPTION

Before describing in detail examples that are in accordance with the present invention, it should be observed that the examples reside primarily in managing forward channel access using a reverse channel. Accordingly, the apparatus and method components have been represented where appropriate by conventional symbols in the drawings, showing only those specific details that are pertinent to understanding the examples of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

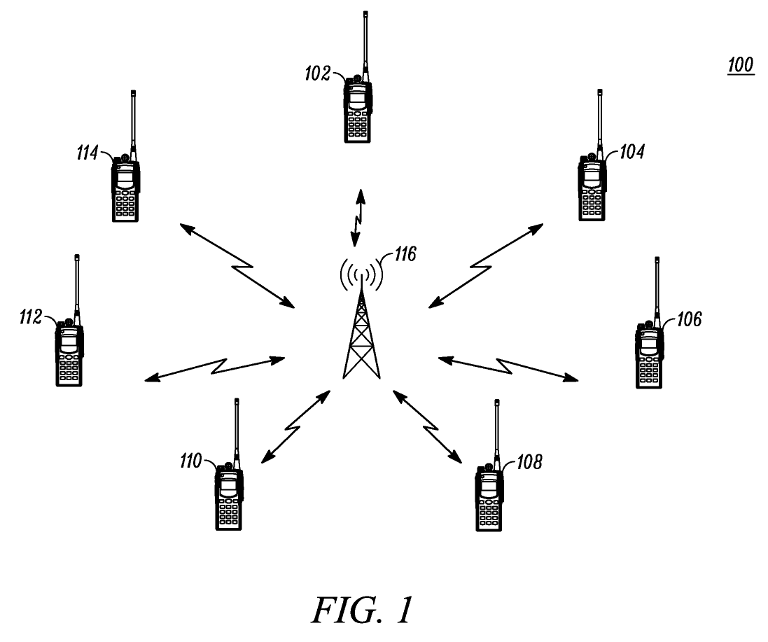

FIG. 1 illustrates a system diagram of a wireless communication system 100, which comprises a plurality of subscribers 102, 104, 106, 108, 110, 112, 114 and at least one repeater 116. The illustrated wireless communication system 100 comprises a talk group wherein one of the subscribers is speaking and the other subscribers are listening. The transmission sent by one subscriber is repeated to the other subscribers by the repeater 116. In one example, the wireless communication system 100 is a Time Division Multiple Access (TDMA) communication system. This system comprises time slots, where each time slot relates to a channel in the TDMA communication system.

A subscriber may be a mobile or a portable device capable of communicating with a repeater and/or another subscriber. Examples of a mobile or a portable device include an in-car or a handheld radio, a radio telephone and a push-to-talk (PTT) device. In any case, each of the subscribers has a priority where the priority is defined as a precedence value identifying an importance of transmissions from the subscriber. Examples of priority include the precedence value being based upon a) a rank of a user associated with the subscriber, b) a type of tasks (e.g. emergency versus non-emergency) performed by a user of the subscriber, and c) a frequency of retransmissions.

An example of priority where the precedence value is based upon a rank of the subscriber follows. If the wireless communication system 100 is used by four police officers, a captain, a sergeant and a lieutenant, the subscribers (e.g. 102,104, 106, 108) associated with the four police officers may be configured to have the least priority. If subscriber 110 is associated with the captain, then it may be configured to have the highest priority. Further, subscribers (e.g. 112 and 114) associated with the lieutenant and sergeant may be configured to have less priority than the sergeant but with greater priority than the four police officers.

In any case, a priority accorded to the subscriber is either static or dynamic. If the priority is static, then the priority is preconfigured or provisioned in the subscriber. In the above example, the subscriber associated with the captain may be provisioned to have a highest priority in the wireless communication system 100. If the priority is dynamic, then the priority is changed depending upon the needs of the wireless communication system 100. For example, if a subscriber is in an emergency situation, then the subscriber may dynamically set its priority to have a higher priority due to the emergency. Another example, if the subscriber is not able to transmit and the messages being sent by the subscriber fail so as to increase the number of retransmissions. In such a case, the priority of the subscriber may be increased so that messages sent from that subscriber are accorded a higher priority.

As used herein, a subscriber transmitting information is known as an active subscriber while the subscriber waiting to transmit after the active subscriber is known as an interested subscriber. For example, if subscriber 102 is transmitting information in a transmission to subscribers 104, 106, 108, 110, 112, 114, then it is considered to be an active subscriber. Further, if subscribers 106 and 110 are both waiting to transmit after subscriber 102 ends the transmission, then subscribers 106, 110 are considered to be interested subscribers.

As used herein, a talk group is a group of subscribers who share common characteristics. Examples of common characteristics include a common functional responsibility, a geographical area, and a working shift. Further, another example of a common characteristic is that a system operator of the wireless communication system 100 set up the talk group with certain subscribers and such a talk group is defined by the system operator. For example, subscribers 102, 104, 106, 108, 110, 112, 114 may form a talk group if the subscribers are all used by fire fighters. Another example, subscribers 102, 104, 106, 108, 110, 112, 114 may form a talk group if the subscribers are all used to support police personnel in the west side of Chicago.

A repeater (e.g. 116) facilitates transmissions among the subscribers in the wireless communication system 100. As is known to one of ordinary skill in the art, a repeater may also be referred to as a base radio, a base station, or a tower. The repeater is generally fixed and provides for communicating data, control, and voice. In any case, a repeater repeats information transmitted by one subscriber of the talk group to the other subscribers listening to the talk group.

In one example, transmissions among the subscribers may take place without a repeater. Such transmissions are known as talkaround. Talkaround occurs where one of the subscribers acts as a repeater. For example, in the absence of repeater 116, subscriber 112 may facilitate a transmission between subscribers 114, 116. As is known, talkaround is also referred to as “direct” or “direct talk.”

Even though an embodiment of the present invention has been described with reference to TDMA, alternatively, the wireless communication system 100 may adhere to other wireless protocols. For example, the wireless communication system 100 may adhere to a Frequency Division Multiple Access (FDMA) system. In such a system, two channels of the system may be designed as a forward channel and a reverse channel so as to manage forward channel access using the reverse channel. Similarly, the wireless communication system 100 may adhere to a Orthogonal Frequency Division Multiplexing (OFDM) system or a Code Division Multiple Access (CDMA) system.

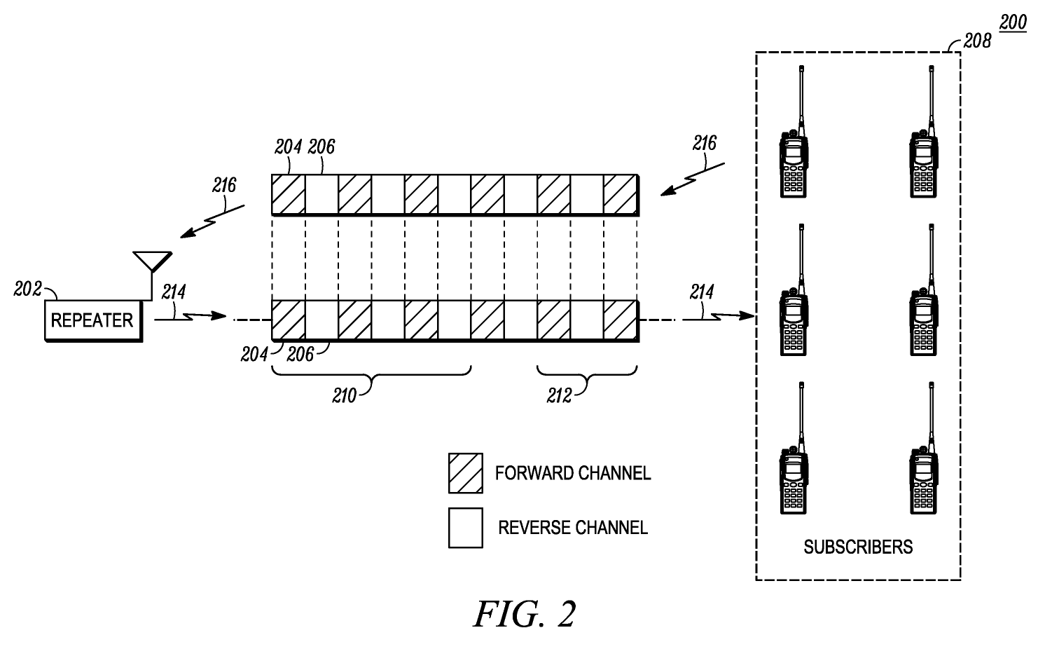

FIG. 2 illustrates a block diagram of a two-slot TDMA system 200. In this example, time slot 204 is allocated to a forward channel and time slot 206 is allocated to a reverse channel. As is known to one of ordinary skill in the art, the forward channel is used for transmissions initiated by a subscriber and destined for one or more subscribers. Thus, the forward channel facilitates transmissions (e.g. voice or data) between endpoints in the wireless communication system 200, namely the subscribers in group 208. In one example, the forward channel not only carries transmissions but also control information.

Conversely, the reverse channel (also known as a “backward” channel) is used for signaling between a subscriber and a repeater. Thus, the reverse channel facilitates signaling (e.g. a request, a repeated request, and a grant) between an intermediary and an endpoint of the wireless communication system 100. For example, signaling that takes place between a subscriber in the group 208 and the repeater 202 while the subscriber is engaged in a transmission takes place on the reverse channel and is known as “reverse channel signaling.” In FIG. 2, such signaling takes place on time slot 206. Since the time slot 206 may be used by a number of subscribers in the group 208 to transmit reverse channel signaling, the time slot 206 is considered a shared slot of the wireless communication system 200.

In any case, a transmission that is initiated by a subscriber (e.g. by pressing PTT) in the group 208, repeated by a repeater 202, and destined for one or more subscribers in the group 208 takes place on the forward channel. In FIG. 2, such a transmission is shown as taking place on time slot 204. In such a transmission, there are two directions of information flow, namely an uplink 216 and a downlink 214. The uplink 216 occurs when a subscriber initiates a transmission with the repeater 202 and the downlink occurs when the repeater repeats the transmission to another subscriber in the group 208.

As illustration, FIG. 2 shows subscribers in group 208 utilizing the forward channel (and hence time slot 204) for a first transmission 210. During this time, subscribers in talk group 208 may request to use the forward channel by sending requests to the repeater 202 on the reverse channel (and hence time slot 206). After the first transmission 210 ends, one of the interested subscribers begins a second transmission 212. This second transmission 212 also takes place on the forward channel. In one example, the forward channel is permanently associated with time slot 204 and the second transmission takes place on time slot 204. However, in a second example, the forward channel may dynamically change from time slot 204 for the first transmission 210 to time slot 206 for the second transmission 212. In such a case, the second transmission 212 takes place on time slot 206.

In any case, the term “transmission” refers to transmitting voice (referred to herein as a “voice transmission”) or data (referred to herein as a “data transmission”) between the subscribers in the wireless communication system. Examples of voice transmissions are phone calls, voice messages, individual calls, talk group calls_, etc. Examples of data transmissions are text messages, e.g. SMS (short messaging service) messages, EMS (enhanced message service) messages, and MMS (multimedia messaging service) messages. Thus, as used herein, reference to a transmission refers to both voice and data.

Even though FIG. 2 illustrates two slots of a TDMA system, the wireless communication system 100 may be configured for any number of slots. Thus, the mention of the number two is only illustrative. For example, a TDMA system may be configured for four slots where two slots are used for the forward channel and two slots are used for the reverse channel. Another example, a TDMA system may be configured for three slots where one slot is used for the forward channel and two slots are used for the reverse channel. Such a system may be useful if the number of subscribers in the system is so large that the amount of reverse channel signaling needs greater bandwidth to accommodate the increased signaling.

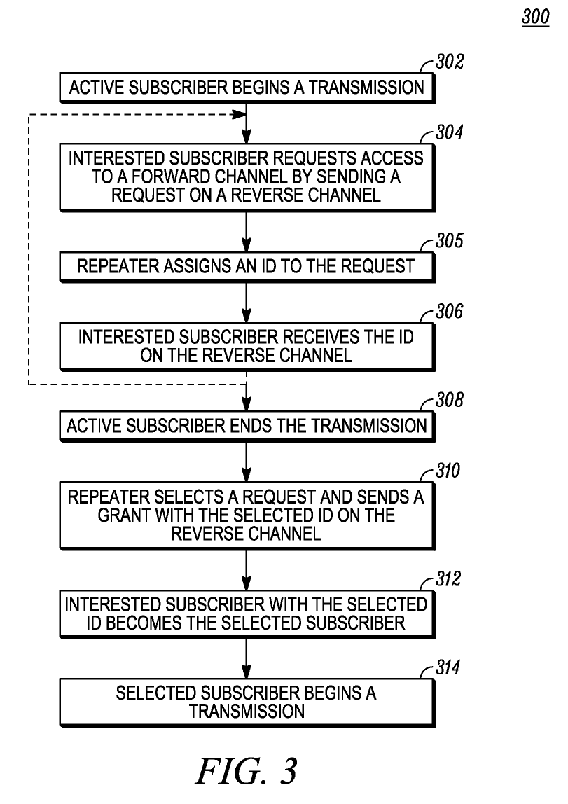

FIG. 3 illustrates a flow diagram of an operation of the wireless communication system 100. An active subscriber begins a transmission (Block 302). As mentioned previously, beginning a transmission occurs, e.g. by pressing PTT. Further, as mentioned previously, the transmission begins on a forward channel of the wireless communication system. While the active subscriber is in a transmission, an interested subscriber requests access to the forward channel by sending a request on the reverse channel (Block 304). The request is sent by the interested subscriber to indicate the interested subscriber's interest in beginning a transmission once the current transmission ends. In one example, the request indicates the type (e.g. voice or data) of transmission that the interested subscriber is interested in beginning. Further, the request also comprises a priority field, which identifies a priority of the subscriber sending the request.

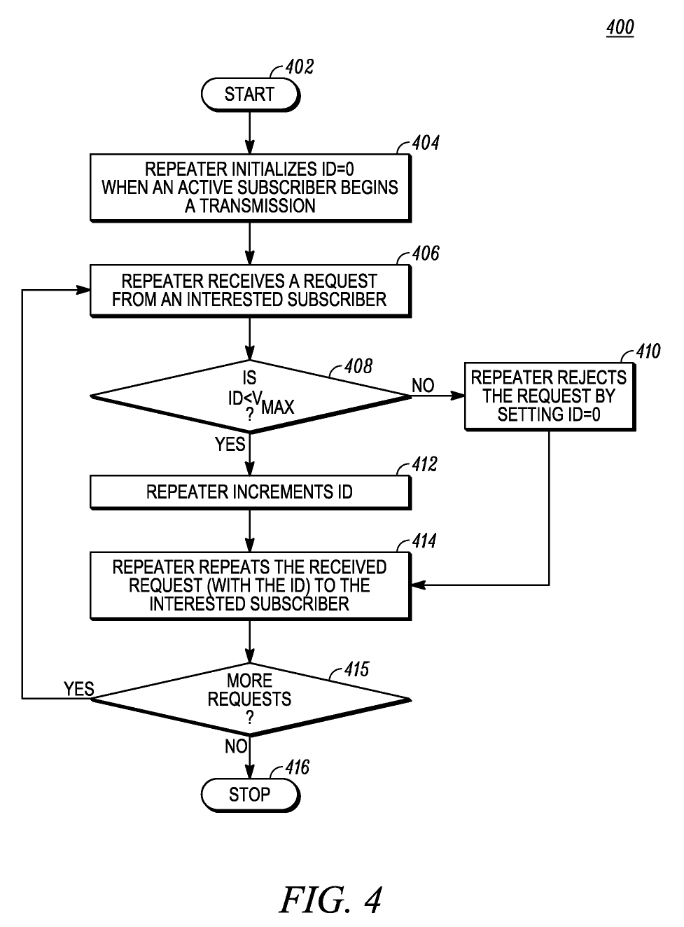

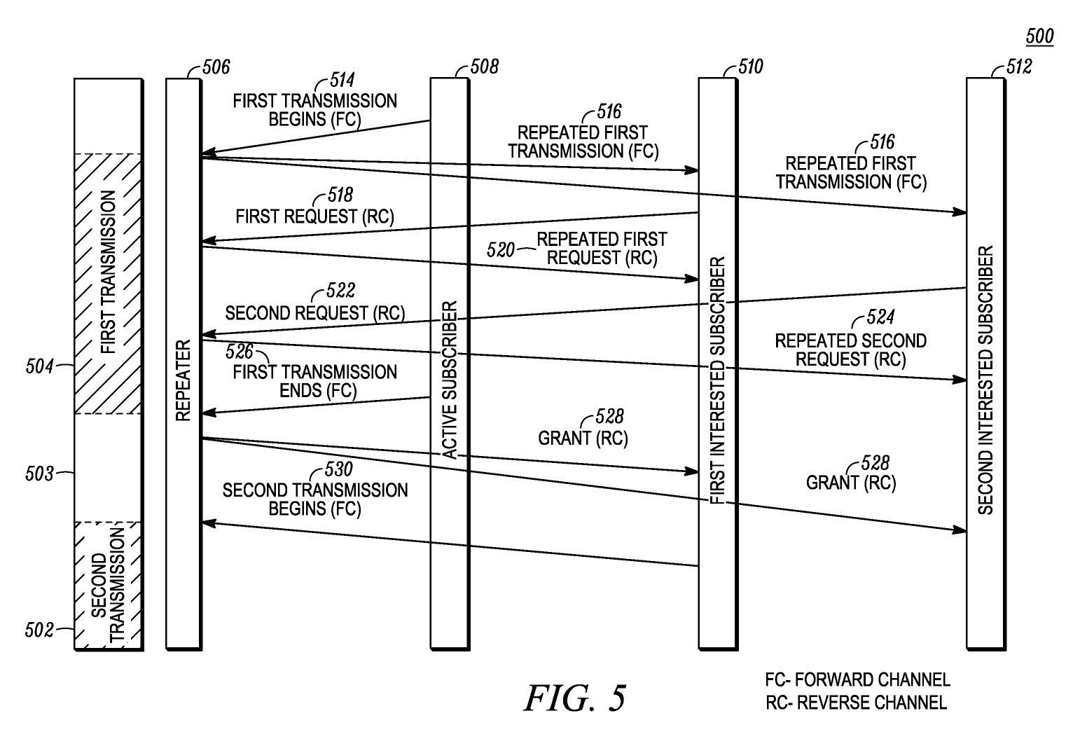

After the request is received by a repeater, the repeater assigns an identifier (ID) to the request (Block 305). Assigning an ID to the request is further discussed with reference to FIG. 4. In any case, the repeater communicates the assigned ID to the interested subscriber on the reverse channel. The interested subscriber receives the ID on the reverse channel (Block 306). As will be discussed with reference to FIGS. 4 and 5, the repeater repeats the received request by replacing the priority with the assigned ID. The assigned ID is used to identify a selected subscriber which has been allowed access to the forward channel.

As shown by the dotted lines, while the forward channel is being used for a transmission, the repeater receives requests on the reverse channel until the transmission by the active subscriber ends. Thus, Blocks 304-306 are repeated during this time. In one example, there is a limit to the number of requests that may be processed by the repeater during the time that the active subscriber is in a transmission. In another example, there is a limit to the number of requests that may be sent by interested subscribers to access the forward channel during this time. In one example, the wireless communication system limits the number of requests processed by the repeater to a predetermined figure. In such an example, the number of requests may be limited to 31.

In any case, when the active subscriber ends the transmission (Block 308), a repeater selects a subscriber among the interested subscribers and sends a grant to a selected subscriber on the reverse channel (Block 310). In one example, selecting a subscriber among the interested subscribers means to prioritize the requests based upon the priority of the interested subscriber. As such, a higher priority subscriber may be given access to the forward channel before a lower priority subscriber. In such an example, the repeater may maintain a table of requests. The table may identify an interested subscriber by the assigned ID and priority. In such an example, the repeater may determine the highest priority in the table and select the assigned ID associated with the request having the highest priority. In any case, the repeater selects one ID from a number of IDs and sends a grant that identifies the selected ID (Block 310). Upon receiving the grant and identifying that the ID matches the ID received previously (Block 306), the interested subscriber with the selected ID becomes the selected subscriber (Block 312). Because the IDs match, the selected subscriber begins a transmission (Block 314). As mentioned previously, the transmission begins on a forward channel of the wireless communication system.

FIG. 4 illustrates a flow diagram of an operation by a repeater to assign an ID to a request sent by an interested subscriber (e.g. Block 305). In this example, a repeater initializes an ID to zero when an active subscriber begins a transmission (Block 404). The repeater receives a request from an interested subscriber (Block 406). If the ID assigned to the request is less than a maximum value (Block 408), then the repeater increments the ID (Block 412). If the ID is more than the maximum value the repeater rejects the request sent by the interested subscriber by setting the ID to zero (Block 410). The repeater then repeats the received request with the ID to the interested subscriber (Block 414). If the transmission has not ended, the repeater determines whether there are more requests (Block 415). If there are more requests, then the repeater receives requests on the reverse channel from interested subscribers until the transmission by the active subscriber ends. Thus, Blocks 406-415 are repeated until the transmission has ended (Block 416). In any case, once the transmission ends, the assigned ID has no value in identifying subscribers in the wireless communication system. As such, the assigned ID is temporarily used to identify subscribers in the wireless communication system, where temporarily means that the ID only has meaning from a time that the repeater repeats the received request with the assigned ID until the transmission ends.

FIG. 5 illustrates a message flow diagram for the wireless communication system 100. An active subscriber 508 begins a first transmission 514 on the forward channel. The first transmission is repeated on the forward channel to a first interested subscriber 510 and a second interested subscriber 512 as a repeated first transmission 516.

As shown in FIG. 5, during the time 504 that the first transmission takes place, a first interested subscriber and second interested subscriber indicate interest in using the forward channel for a second transmission once the first transmission ends. To indicate interest, a first interested subscriber 510 sends a first request 518 to the repeater 506 on the reverse channel. The repeater repeats the first request 518 on the reverse channel (referred to as a repeated first request 520). To indicate interest, a second interested subscriber 512 sends a second request 522 to the repeater 506 on the reverse channel. The repeater repeats the second request 522 on the reverse channel (referred to as repeated second request 524). The first request 518 and the second request 522 are sent during a time period 504 for the first transmission.

After the active subscriber 508 ends the first transmission 526 on the forward channel, a time lapse 503 follows before the second transmission 502 begins. During this time lapse 503, the repeater selects and allows access to one of the first and second interested subscribers, 510 and 512, for transmission on the forward channel. As mentioned previously, the selection between the first subscriber and the second subscriber may occur based upon a priority of the subscriber (e.g. 310). In any case, the repeater then sends a grant 528 to the first interested subscriber 510 and the second interested subscriber 512 on the reverse channel. In this example, the first interested subscriber 510 identifies the ID in the grant as its temporarily assigned ID and understands that it is the selected subscriber for transmission on the forward channel. Thus, the first interested subscriber begins a second transmission 530.

In one example, the requests and grants shown in FIG. 5 are 11-bit messages. The 11-bit message may comprise 3 bits for an opcode field, 5 bits for information, and 3 bits for an error check. In one example of the 11-bit message, the 3 bits for the opcode field identify a type of message. As such, the opcode field may uniquely identify a request as a “request to transmit” message and a grant as a “grant to transmit” message. If the opcode identifies the message as a “request to transmit” message and the message is from a subscriber to a repeater, then the 5 bits for information identify a priority associated with the “request to transmit” message. Since there are 5 bits available to communicate a priority, there may be a priority range from 0-31 for identifying 32 unique priorities. If the opcode identifies the message as a “request to transmit” message and the message is from a repeater to a subscriber, then the 5 bits for information identify an ID for the subscriber associated with the “request to transmit” message. As mentioned previously, this ID is temporarily used to identify the subscriber. In any case, since there are 5 bits available to communicate an ID, there may be an ID range from 0-31 for identifying 32 unique subscribers. In one example, setting the ID field to a predetermined value, e.g. a zero value, may identify a rejection of the “request to transmit” message. If the opcode identifies the message as a “grant to transmit” message, the 5 bits of information identify an ID sent to communicate the selected subscriber.

In the foregoing specification, specific examples of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for managing forward channel access using a reverse channel of a wireless communication system, the method comprising the steps:
at a repeater:
receiving a plurality of requests on a reverse channel for access to the forward channel, wherein each request of the plurality of requests comprises a priority of the request;
selecting a request based upon the priority;
allowing access to the forward channel for a transmission based upon the selected request.

2. The method of claim 1 further comprising communicating on the forward channel with a subscriber in a transmission prior to receiving the plurality of requests.

3. The method of claim 1 wherein the forward channel is a first time slot of a TDMA system and the reverse channel is a second time slot of the TDMA system.

4. The method of claim 1 further comprising assigning an identifier to each received request.

5. The method of claim 4 further comprising repeating the received requests by replacing the priority with the assigned identifier.

6. The method of claim 1 wherein selecting a request further comprises determining a highest priority of the received requests.

7. The method of claim 1 wherein each received request is a request for the transmission.

8. The method of claim 7 wherein the transmission is at least one of voice and data.

9. The method of claim 1 wherein the allowing access further comprises sending a grant on the forward channel for the selected request, wherein the grant identifies a subscriber selected for the transmission.

10. A method for communication in a wireless communication system, wherein the wireless communication system comprises a plurality of subscribers and at least one repeater, the method comprising the step:
at a repeater:
communicating on a forward channel with an active subscriber, whereby the active subscriber is in a transmission;
receiving a first request by a first interested subscriber of a plurality of interested subscribers on a reverse channel, wherein the first request contains a first priority;
repeating the first request to the first interested subscriber on the reverse channel, wherein the repeated first request contains a first identifier value;
receiving a second request by a second interested subscriber of a plurality of interested subscriber on the reverse channel, wherein the second request contains the second priority;
repeating the second request to the second interested subscriber on the reverse channel, wherein the repeated second request contains a second identifier value; and
selecting one of the first interested subscriber and the second interested subscriber to communicate on the forward channel after the active subscriber ends the transmission.

11. The method of claim 10 wherein the active subscriber, the first interested subscriber, the second interested subscriber, and the repeater comprise a talk group in the wireless communication system.

12. The method of claim 10 wherein the wireless communication system is a TDMA system.

13. The method of claim 10 further comprising determining that the first identifier value is greater than a maximum value to reject the first request.

14. The method of claim 10 further comprising determining that the first identifier value is less than a maximum value to increment the first identifier value.

15. The method of claim 10 wherein selecting further comprises:
determining a highest priority of the first priority and the second priority; and
sending a grant based on the highest priority to one of the first request and the second request.

16. A method for transmitting in a wireless communication system, the method comprising the steps:
at a subscriber:
requesting access to a forward channel for a transmission by sending a request on a reverse channel, wherein the request comprises of a priority;
receiving an identifier value on the reverse channel based upon the request, wherein the identifier value identifies the subscriber;
receiving a grant on the reverse channel, wherein the grant allows the subscriber access to the forward channel for the transmission; and
communicating on the forward channel, if the received grant has an identifier value matching the received identifier value.

17. The method of claim 16 wherein the request is a request to transmit message, wherein the request to transmit message is transmitted on the forward channel.

18. The method of claim 16 wherein the identifier value temporarily identifies the subscriber.

19. The method of claim 16 wherein the priority identifies a precedence value of the subscriber.

20. The method of claim 16 wherein the priority depends upon at least one of the following a) a rank of a user of the subscriber, b) a type of tasks performed by a user of the subscriber, and c) a frequency of retransmissions.
